(19) United States
(12) Patent Application Publication
(10) Pub. No.: US 2008/0300737 A1
(43) Pub. Date: Dec. 4, 2008

(54) METHOD AND DEVICE FOR CALCULATING A FLIGHT PLAN

(75) Inventors: Jerome SACLE, Toulouse (FR); Francois Coulmeau, Seilh (FR); Stephanie Fortier, Cugnaux (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/129,212

(22) Filed: May 29, 2008

(30) Foreign Application Priority Data
May 29, 2007 (FR) 0703784

(51) Int. Cl. G01C 21/36

(52) U.S. Cl. 701/3

(57) ABSTRACT

The invention relates to a method for calculating a diversion flight plan making it possible to define at least one diversion airport to have the associated predictions on the corresponding diversion flight plan. The invention also relates to a device comprising means implementing the method according to the invention. The device according to the invention makes it possible to change, in the course of the flight, the said waypoint from which the diversion flight plan is calculated. The method according to the invention furthermore calculates the last possible diversion point on the flight plan, based on the fuel predictions.

### RELATED APPLICATIONS

The present application is based on, and claims priority from, French Application Number 07 03784, filed May 29, 2007, the disclosure of which is hereby incorporated by reference herein in its entirety.

### FIELD OF THE INVENTION

The invention relates to a method and a device for calculating a flight plan of an aircraft and more particularly a diversion flight plan.

### BACKGROUND OF THE INVENTION

A flight plan is a detailed description of the trajectory to be followed by an aircraft within the framework of a scheduled flight. It comprises notably a route, which is a chronological sequence of waypoints described by their position, altitude and transit time. The waypoints will be followed by the aircraft if the latter complies fully with its flight plan, which thus constitutes a valuable aid both to the control personnel on the ground and also to the flight personnel on board for anticipating the movements of the aircraft and ensuring an optimum safety level.

The flight plan is commonly managed by a flight management system that will be called the FMS subsequently. The FMS determines the geometry of the vertical profile, and dispatches the guidance instructions for following this profile to the pilot or to the automatic pilot. FIG. 1 represents an FMS according to the known art having the following functions:
The navigation LOCNAV 170 performs optimal location of the aircraft as a function of the geolocation means 171 (GPS, GALILEO, VHF radio beacons, inertial platforms).
The flight plan FPLN 110 makes it possible to input the geographical elements constituting the skeleton of the route to be followed: departure and arrival procedures, waypoints and aerial routes (called “airways”).
A navigation database NAVDB 130 makes it possible to construct geographical routes and procedures using data included in the bases (points, beacons, interception or altitude legs, etc.).
A performance database PRF DB 150 contains the craft's aerodynamic and engine parameters.
The lateral trajectory module TRAJ 120 constructs a continuous trajectory on the basis of the points of the flight plan, complying with the aircraft performance and the confinement constraints (RNP).
The prediction module PRED 140 constructs a vertical profile optimized on the lateral trajectory.
The guidance module GUIDANCE 200 guides the aircraft on its 3D trajectory in the lateral and vertical planes while optimizing the speed and communicating with an automatic pilot 201.
A digital data link DATALINK 180 makes it possible to communicate with the control centres 181 and the other aircraft.

According to the known art, the formulation of a flight plan is done inter alia, on the basis of imposed waypoints possibly associated with altitude, time and speed constraints. These imposed waypoints and their associated constraints are introduced, into the FMS flight computer, by the crew of the aircraft, by means of an item of equipment of the flight deck with keyboard and screen ensuring the man-machine interface 111 such as that known by the name MCDU from the expression: “Multipurpose Control and Display Unit”. The formulation proper consists in constructing the lateral and vertical trajectories of the flight plan by stringing together a chain of straight segments starting from a departure point, passing through the imposed waypoints and ending at an arrival point, complying with standardized construction rules, taking account of altitude and speed constraints associated with each imposed waypoint and aircraft parameters (mass, cruising levels, optimization criteria, etc.).

In general, a flight plan comprises, furthermore, at least one diversion airport and an associated flight plan called the diversion flight plan. This diversion airport is intended to receive the aircraft notably in the event of faults (engine fault, depressurization, etc.) or during flights performed at the limit of range, that is to say when the aircraft travels a distance requiring the consumption of almost all the fuel on board.

According to the known art, the diversion flight plan is defined in an FMS as a flight plan beginning from the destination. In general this diversion flight plan does not comprise any prediction (for transit time, altitude, speeds and fuel at the waypoints). Certain FMSs calculate predictions on this diversion flight plan but these predictions are performed by assuming a descent down to the initial airport, followed by a climb back up to reach the diversion airport. No possibility exists of inserting a diversion flight plan from any diversion waypoint of the flight plan, by obtaining a calculation of predictions on this section using the context (altitude, speed, time, fuel) predicted at the diversion point, and updated in real time. Moreover, in general a single diversion flight plan can be created.

When it is necessary to define a diversion flight plan starting from an arbitrary point of the trajectory, the only alternative is to create a “secondary” flight plan in addition to the normal or “active” flight plan. The active flight plan is that made available by the FMS system and taken permanently as reference by the onboard systems. The secondary flight plan is initially the copy of the active flight plan and allows the flight personnel to manually modify the flight plan to take new characteristics or parameters into account, while ensuring the permanence of the active flight plan, that is to say without disturbing the systems which take it as reference. Once the modifications have been terminated on the secondary flight plan, the latter can become the active flight plan and vice versa when ordered by the flight personnel. So only the onboard systems are informed by the FMS system of the updating of the flight plan. However, the secondary flight plan thus calculated is static in the sense that the diversion point has been chosen by the crew and cannot be updated and optimized in real time as a function of the progress of the flight. Moreover, with each modification of the active flight plan, it is necessary to reprogram a secondary flight plan thereby entailing additional workload. Finally, this manipulation monopolizes a secondary flight plan, which is no longer available for other activities.

### SUMMARY OF THE INVENTION

The invention is aimed at alleviating the problems cited previously by proposing a method and a device for calculating a diversion flight plan making it possible to define as many diversion airports as necessary and to have the associated predictions on the corresponding diversion flight plans.

An advantage of the method according to the invention is the calculation of a diversion flight plan from any waypoint of the active trajectory. Moreover, the device according to the invention makes it possible to change, in the course of the flight, the said waypoint from which the diversion flight plan is calculated.

Another advantage of the method according to the invention is the calculation and the updating in real time of the predictions associated with the diversion flight plan.

The method according to the invention furthermore calculates the last possible diversion point on the flight plan based on the fuel predictions.

For this purpose, the subject of the invention is a method for calculating a flight plan of an aircraft, the said flight plan comprising an active flight plan leading to a first destination and at least one diversion flight plan that can be followed by the aircraft in the event of a fault, starting from a waypoint related to the active flight plan, called a junction point, and leading to a second destination, the said aircraft comprising a flight management system comprising a function for predictions associated with the active flight plan, of the altitude, speed, transit time and fuel aboard the said aircraft characterized in that it comprises the following steps:
the calculation, by the flight management system, of predictions associated with the said diversion flight plan comprising the fuel reserve remaining on arrival at the second destination, as a function:
   of the mass of the aircraft,
   of the predictions on the altitude, the speed and the fuel aboard the said aircraft at the junction point,
   of the winds considered at the said junction point and along the diversion route and
   of the type of fault entailing the diversion,
the display of the said diversion flight plan and of the said associated predictions.

According to a variant of the invention, the junction point can be moved along the active trajectory.

According to a variant of the invention, the method for calculating a flight plan of an aircraft furthermore comprises the following steps:
the calculation of an optimal altitude on the diversion flight plan taking into account constraints of minimum safety altitudes, altitude constraints at the waypoints and constraints related to predefined zones,
the calculation of an estimation of the fuel consumed by the aircraft to reach the second destination by taking into account the optimal altitude on the diversion flight plan.

According to a variant of the invention, the method for calculating a flight plan of an aircraft furthermore comprises the calculation of the position of the junction point on the active flight plan where the diversion allows the aircraft to reach the second destination with a fuel reserve that is equal to a value determined in advance, the said calculation being repeated periodically in the course of the flight.

According to a variant of the invention, the method for calculating a flight plan of an aircraft furthermore comprises a step of automatically cancelling the diversion flight plan after passing the junction point.

The subject of the invention is also a device for calculating a flight plan of an aircraft, characterized in that it comprises means implementing the method according to the invention.

According to a variant of the invention, the device for calculating a flight plan of an aircraft comprises means for inputting and displaying the diversion flight plan.

According to a variant of the invention, the device for calculating a flight plan of an aircraft furthermore comprises means for activating the diversion flight plan.

According to a variant of the invention, the device for calculating a flight plan of an aircraft furthermore comprises means for displaying alternatively, the whole of the diversion flight plan in the active flight plan, a line summarizing the location of the diversion flight plan at the junction point of the active flight plan.

According to a variant of the invention, the device for calculating a flight plan of an aircraft furthermore comprises means for calculating and displaying on a dedicated page the various quantities of fuel for flying the diversion flight plan as well as the associated reserves.

According to a variant of the invention, the device for calculating a flight plan of an aircraft furthermore comprises means for displaying on a navigation screen at the level of the junction point, the estimated quantity of fuel on arrival at the second destination.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents an FMS architecture according to the known art.

FIG. 2 represents a flight plan comprising a diversion flight plan.

FIG. 3 represents a waypoint lateral revision page.

FIG. 4 represents a flight plan page comprising an empty diversion flight plan.

FIG. 5 represents a flight plan page comprising the diversion flight plan of FIG. 4 to which waypoints have been added.

FIG. 6 presents a flight plan comprising a masked diversion flight plan.

FIG. 7 presents a display dedicated to the fuel predictions on the diversion flight plan.

FIG. 8 represents the diversion flight plan represented in FIG. 5 but presenting a different junction point.

FIG. 9 illustrates a flight plan page after activation of the diversion flight plan represented in FIG. 5.

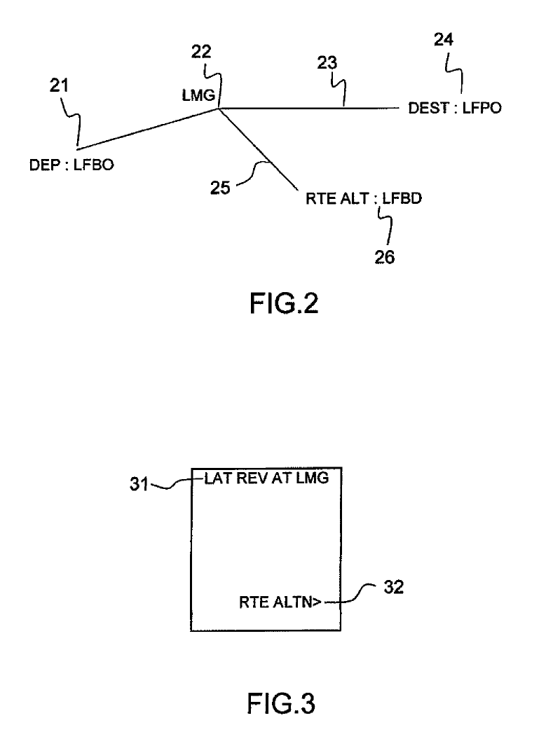

FIG. 2 represents an exemplary flight plan linking a departure airport LFBO 21 and a destination airport LFPO 24 and comprising a diversion flight plan 25 linking a junction point LMG 22 to a diversion airport LFBD 26.

### DETAILED DESCRIPTION OF THE INVENTION

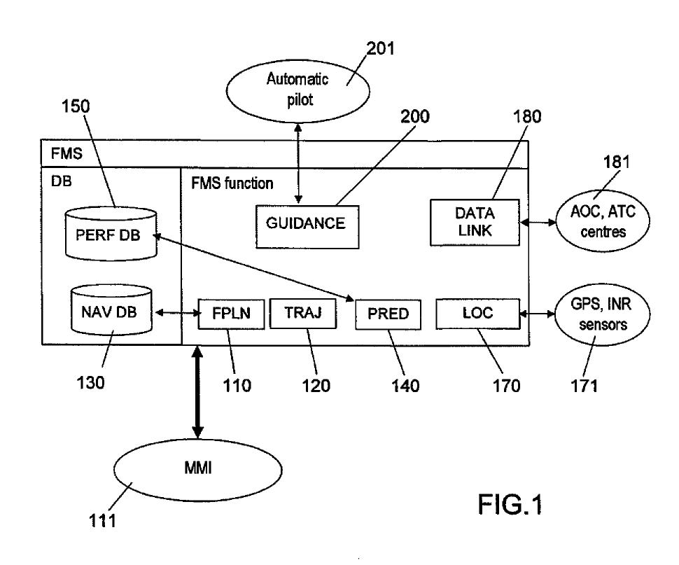

The invention relates to a method for calculating a diversion flight plan making it possible to define as many diversion airports as necessary and to have the associated predictions on the corresponding diversion flight plans. The invention also relates to a device comprising means 110, 120, 140 implementing the method according to the invention. The device according to the invention can be applicable either for an FMS with conventional MCDU, forming part of the man-machine interface 111 in FIG. 1, using key presses, or for a new-generation interactive FMS in which access to the functions is achieved by selection with the aid of a cursor similar to the computer “mouse” device. Subsequently, the case of an FMS with conventional MCDU will be considered by way of nonlimiting example.

The device according to the invention comprises means for inputting and displaying the diversion flight plan. FIG. 3 represents a lateral revision page for a waypoint 31. The said revision page affords access to a function “RTE ALTN>” 32 for creating a diversion flight plan. The said function can apply to a waypoint or to a point referenced with respect to a waypoint of the active flight plan, positioned at a distance before or after (Place—Distance type, for example LMG/20 Nm after).

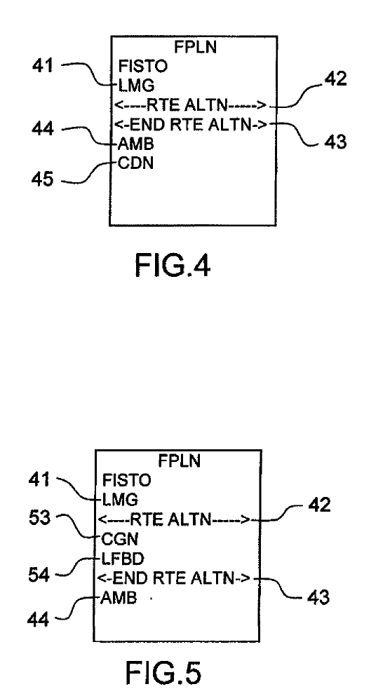

FIG. 4 represents a flight plan page comprising an empty diversion flight plan with the selected point 41 as reference diversion point. The diversion flight plan is delimited by a first line <-RTE ALTN-> 42 and a second line <-END RTE ALTN-> 43. The device according to the invention comprises means for adding points 44, 45 and airways on the same principle as for the active flight plan. FIG. 5 represents a flight plan page comprising the diversion flight plan of FIG. 4 to which waypoints have been added. The said means make it possible to add points to the flight plan 53, a destination 54, an arrival procedure and weather data (winds, temperature) directly into the flight plan. This flight plan will be displayed on the navigation screen ND forming part of the MMI in FIG. 1 to facilitate its construction and to view it.

The diversion flight plan is inserted coloured blue for example, at the level of the flight plan between the first line <-RTE ALTN-> 42 and a second line <-END RTE ALTN-> 43. The diversion flight plan is included in the active flight plan as a route option from the junction point.

To erase the whole of a diversion flight plan, the CLR key on the MCDU MMI is pressed for example to erase the line <-RTE ALTN-> 42 or <-END RTE ALTN-> 43 with possible confirmation for the FMSs which create a temporary flight plan following this operation.

According to a characteristic of the invention, the device for calculating a diversion flight plan furthermore comprises means for activating the diversion flight plan. The diversion flight plan is activated from the junction point (LMG in the example) by the activation button on the MCDU MMI which replaces the RTE ALTN access button once the diversion flight plan has been created at this waypoint. Alternatively, the activation of the diversion flight plan can be effected by selection at the level of the line <----RTE ALTN-----> 42 of the page of the flight plan.

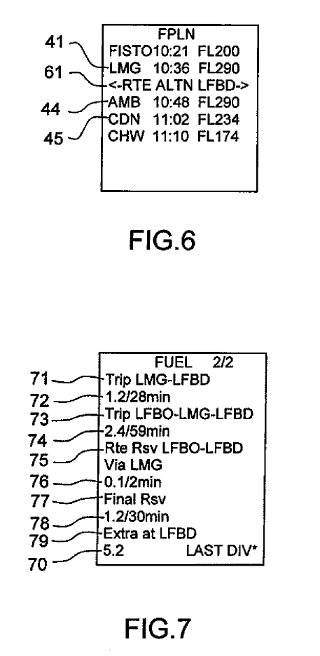

According to a characteristic of the invention, the device for calculating a diversion flight plan furthermore comprises means for displaying alternatively according to the selection, the whole of the diversion flight plan in the active flight plan, between two lines 42,43 from the junction point or displaying a line summarizing the location of the diversion flight plan at the junction point of the active flight plan (masking function). FIG. 6 presents a flight plan comprising a masked diversion flight plan. It is possible to fold away (masking) or to reveal the diversion flight plan by selecting the line <----RTE ALTN LFBD----> 61 where LFBD is the last waypoint entered into the diversion flight plan. The advantage of masking is to decrease the overall proportions of the FPLN page if the diversion flight plan is lengthy. Nevertheless through a fast action it is called to display it again and vice versa.

In flight, the predictions (fuel, time, altitude, speed) are viewed directly on the diversion flight plan, while retaining the pages of the active flight plan in visual. Contrary to a secondary flight plan, the predictions are updated in real time in the course of the flight. The basis for the calculation of the predictions on the diversion flight plan is the mass, altitude, speed, fuel on board, all predicted at the junction point (LMG in the example), and the winds considered at this point and along the diversion route.

The predictions are calculated by taking into account the type of fault which relates to the diversion portion. It is possible to choose, for example, from among this non-exhaustive list:
No fault (No failure): in this case, the method according to the invention uses a vertical profile identical to the current vertical profile, and a default descent/approach, such as done on contemporary systems.
Engine fault (Engine Failure): in this case, the method according to the invention recovers from the FMS the altitude and the speed termed ‘EO’ (for Engine Out) which are advocated in the event of an engine fault. It calculates a descent to the restoral altitude, with deceleration to the engine-fault target speed, as far as a zone close to arrival, where it then uses a default descent/approach.
Depressurization: in this case, the method according to the invention uses an immediate descent to a level compatible with the depressurization (e.g. 10000 feet), then maintains this altitude as far as a zone close to the airport where it calculates a default descent/approach.

The refreshing of the predictions can be performed according to the same frequency or at a lower frequency than that of the refreshing of the predictions of the active flight plan.

The predictions (time, altitude, fuel, speed) evolve in parallel from the junction point LMG 41 at 10h36.

According to a characteristic of the invention, the device for calculating a diversion flight plan furthermore comprises means for calculating and displaying on a dedicated page the various quantities of fuel for flying the diversion flight plan as well as the associated reserves.

FIG. 7 presents a display dedicated to the fuel predictions on the diversion flight plan. Such a display comprises the forecasts in terms of fuel consumption and travel time on the diversion stretch LMG-LFBD 71 in the example: 1.2 tonnes of fuel consumed and 28 minutes of flight time 72. The Fuel page can furthermore display the forecasts in terms of fuel consumption and travel time on the whole of the journey leading from the departure airport to the diversion airport LFBO-LMG-LFBD 73 in the example: 2.4 tonnes of fuel consumed and 59 minutes of flight time 74.

The Fuel page can furthermore display the following fuel predictions:

“extra” 79 that is to say the quantity of fuel on arrival at the second destination, 5.2 tonnes 70 in the example,

“Rte rsv” 75, that is to say the additional quantity of fuel to alleviate chance eventualities on the route, 0.1 tonnes in the example corresponding to 2 minutes of flight 76,

“Final rsv” 77 the additional quantity of fuel to alleviate chance eventualities on the terminal arrival zone (a wait for example), 1.2 tonnes in the example corresponding to 30 minutes of flight 78.

The display of the flight plan on the navigation screen (ND) will be able to include at the junction point (LMG in the example), the predicted quantity of Fuel on arrival at the diversion airport (LFBD). This value is updated periodically.

The method according to the invention furthermore calculates the quantity Extra of Fuel on arrival at the alternate airport en route (LFBD). The quantity Extra is equal to the quantity of Fuel on departure (LFBO) minus the sum of the quantities Trip (LFBO-LMG-LFBD)+Rte reserve (LFBO-LMG-LFBD)+Final reserve (LFBD). Should the quantity Extra become negative, a message to the FMS alerts the pilot. The values of the reserves can be modified manually. In flight, the Rte Rsv (route reserve) vanishes when the en-route alternate flight plan becomes active, the quantity of reserve being transferred into the field Extra in addition with the Extra Fuel considered. If the Extra Fuel becomes less than the Final reserve, a message alerts the pilot.

These forecasts allow the pilot, on arriving at the decision point, to evaluate the fuel scheduled at destination in relation to the regulatory minimum (Extra for the destination). On the basis of the predictions calculated on the en-route diversion flight plan, he evaluates the fuel remaining at the en-route diversion airport (Extra for the diversion).

According to a characteristic of the invention, the method for calculating a diversion flight plan furthermore comprises the following steps:
the calculation of an optimal altitude on the diversion flight plan taking into account constraints of minimum safety altitudes, altitude constraints at the waypoints and constraints related to military zones subject to restriction,
the calculation of an estimation of the fuel consumed by the aircraft
to reach the second destination by taking on the optimal altitude on the diversion flight plan.

Given the importance accorded to the calculation of the Fuel predictions, specially for the calculation of the last possible diversion point on the flight plan, the predictions must be as accurate as possible. To improve the prediction model, assuming that the lateral flight plan as far as the diversion airport has been fully entered including the arrival and the approach, one seeks to calculate in the vertical plane an optimal cruising altitude, taking into account the following elements:
the Grid Mora, defining a safety altitude at every point of the globe, on the diversion route from the junction point,
the zones subject to restriction, in particular military zones, when available in the database (zones, P, R, D with their volume and upper limit),
the distance between the junction point and the diversion airport.

Advantageously, on the basis of these three items of information, and by including the altitude constraints at the waypoints of the diversion flight plan, the method according to the invention determines an optimal flight level on the diversion flight plan.

According to a variant of the method according to the invention, the junction point can be moved along the active trajectory. So long as the diversion flight plan has not been erased, the pilot can transfer it to another waypoint of the flight plan by calling it completely with the dedicated button “RTE ALTN >” under lateral revision at the selected waypoint and can modify it at his convenience. This makes it possible to translate this stretch along the flight plan so as to use the function smoothly for an en route diversion.

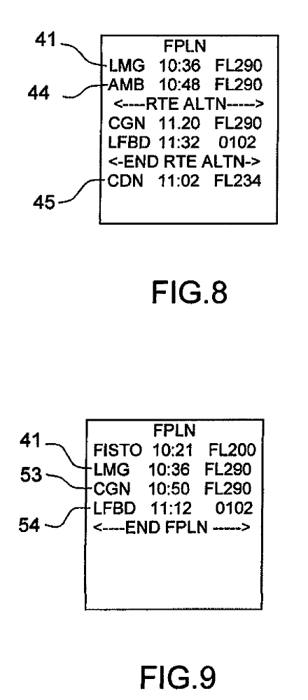

FIG. 8 represents the diversion flight plan represented in FIG. 5 but presenting a different junction point. The junction point has been modified from LMG to AMB. Consequently, on the FPLN page, the predictions are recalculated from the junction AMB instead of LMG, taking account again of the initial characteristics of mass, fuel, altitude and speed at the point AMB. This shifting can be iteratively repeated.

At any moment, the pilot can activate the diversion flight plan or decide to continue.

According to a variant of the method according to the invention, when the pilot chooses to continue the flight on the active flight plan and when the decision point passes behind the point FROM (that is to say behind the aircraft) of the flight plan, it is no longer possible to activate the diversion flight plan and this flight plan is erased automatically after a warning message.

According to another variant of the method according to the invention, the erasure of the diversion flight plan is manual. The pilot keeps control but having an additional action to his credit with respect to the automatic process. When the junction point passes the waypoint FROM, the predictions of the diversion flight plan are calculated on the basis of an about-turn, returning to the predetermined point and continuing the diversion route.

The device for calculating a diversion flight plan of an aircraft according to the invention furthermore comprises means for activating the diversion flight plan.

When the diversion flight plan is activated, its colour becomes that of the active flight plan, the previously active flight plan is erased, or may advantageously itself become a diversion flight plan (SWAP function). At the moment of activation a temporary flight plan allows the verification of the new flight plan considered for confirmation. Cancellation of the confirmation makes it possible to reconsider the diversion flight plan.

Confirmed activation of the diversion flight plan rapidly erases the section of the active flight plan up to the destination. The Fuel pages are simplified accordingly.

FIG. 9 illustrates a flight plan page after activation of the diversion flight plan from LMG 41 the junction to CGN 53 and the destination LFBD 54. The waypoints of the previous active flight plan AMB 44, CDN 45 are erased.

According to a variant of the method for calculating a flight plan of an aircraft according to the invention, the said method furthermore comprises the calculation of the last point where the aircraft can be diverted to the second destination in such a way that the said aircraft reaches the said second destination with fuel reserves complying with regulatory minimum reserves, the said calculation being repeated periodically in the course of the flight. This variant of the method according to the invention consists in calculating the last possible diversion point on the flight plan, automatically creating a floating waypoint (pseudo waypoint) “(L-DIV)” for “Last Diversion” as being the last diversion point to the en-route diversion airport with the regulatory reserves on arrival (the final reserve) and an extra fuel at zero. The function may be activated through the FUEL page dedicated to the en-route diversion. This results in the calculation of the pseudo waypoint (L-DIV) inserted into the flight plan and displayed on the ND.

The last diversion point (Last Diversion) makes it possible to consider the last possible moment of a diversion to an alternate aerodrome en route with the final reserve at the minimum within the framework of a flight to an isolated airport or in the case of a flight to a destination airport whose weather minima are below those requested while preparing the flight to this airport.

According to a variant of the method for calculating a flight plan of an aircraft according to the invention, the said method furthermore comprises the calculation of the position of the junction point on the active flight plan where the diversion allows the aircraft to reach the second destination with a fuel reserve that is equal to a value determined in advance, the said calculation being repeated periodically in the course of the flight. For example, the pilot can define a diversion point with 4 tonnes of fuel envisaged on arrival at the diversion airport. To do this calculation, it is possible to use in an advantageous manner the computational scheme set forth in French patent application No. 2 894 705.

The pseudo waypoint “Last Div” is a particular case, representing by definition a quantity of fuel predicted at destination equal to the Final reserve.

At the flight preparation stage the pilot can enter a 3% (decision point) or 5% route reserve to the alternate airport (LFBD), the field being manually modifiable in the FUEL page dedicated to this diversion flight plan.

In the case of a flight with predetermined point the Fuel page makes it possible to consider the regulatory fuel reserves for the flight to the alternate airport (LFBD) with by default a final reserve equal to 30 minutes at 1500 ft above the alternate airport.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for calculating a flight plan of an aircraft, wherein said flight plan has an active flight plan leading to a first destination and at least one diversion flight plan that can be followed by the aircraft in the event of a fault, starting from a junction point related to the active flight plan, and leading to a second destination, the aircraft has a flight management system including a function for predictions associated with the active flight plan, of the altitude, speed, transit time and fuel aboard the aircraft comprising the following steps:
calculating, by the flight management system, of predictions associated with the diversion flight plan comprising the fuel reserve remaining on arrival at the second destination, as a function:
of the mass of the aircraft,
of the predictions on the altitude, the speed and the fuel aboard the said aircraft at the junction point,
of the winds considered at the said junction point and along the diversion route and
of the type of fault entailing the diversion,
displaying the diversion flight plan and of the associated predictions.

2. The method for calculating a flight plan of an aircraft according to claim 1, wherein the junction point can be moved along the active trajectory.

3. The method for calculating a flight plan of an aircraft according to claim 1, furthermore comprising the following steps:
calculating an optimal altitude on the diversion flight plan taking into account constraints of minimum safety altitudes, altitude constraints at the waypoints and constraints related to predefined zones,
calculating an estimation of the fuel consumed by the aircraft to reach the second destination by taking into account the optimal altitude on the diversion flight plan.

4. The method for calculating a flight plan of an aircraft according to claim 1, furthermore comprising the calculation of the position of the junction point on the active flight plan where the diversion allows the aircraft to reach the second destination with a fuel reserve that is equal to a value determined in advance, the said calculation being repeated periodically in the course of the flight.

5. The method for calculating a flight plan of an aircraft according to claim 1, furthermore comprising a step of automatically cancelling the diversion flight plan after passing the junction point.

6. A device for calculating a flight plan of an aircraft, comprising means implementing the method according to claim 1.

7. The device for calculating a flight plan of an aircraft according to claim 6, comprising means, for inputting and displaying the diversion flight plan.

8. The device for calculating a flight plan of an aircraft according to claim 6, furthermore comprising means for activating the diversion flight plan.

9. The device for calculating a flight plan of an aircraft according to claim 7, furthermore comprising means for displaying alternatively, the whole of the diversion flight plan in the active flight plan, a line summarizing the location of the diversion flight plan at the junction point of the active flight plan.

10. The device for calculating a flight plan of an aircraft according to claim 7, furthermore comprising means for calculating and displaying on a dedicated page the various quantities of fuel for flying the diversion flight plan as well as the associated reserves.

11. The device for calculating a flight plan of an aircraft according to claim 7, furthermore comprising means for displaying on a navigation screen at the level of the junction point, the estimated quantity of fuel on arrival at the second destination.

12. The method for calculating a flight plan of an aircraft according to claim 2, furthermore comprising the following steps:
calculating an optimal altitude on the diversion flight plan taking into account constraints of minimum safety altitudes, altitude constraints at the waypoints and constraints related to predefined zones,
calculating an estimation of the fuel consumed by the aircraft to reach the second destination by taking into account the optimal altitude on the diversion flight plan.

13. The method for calculating a flight plan of an aircraft according to claim 2, furthermore comprising the calculation of the position of the junction point on the active flight plan where the diversion allows the aircraft to reach the second destination with a fuel reserve that is equal to a value determined in advance, the said calculation being repeated periodically in the course of the flight.

14. The method for calculating a flight plan of an aircraft according to claim 2, furthermore comprising a step of automatically cancelling the diversion flight plan after passing the junction point.

15. The device for calculating a flight plan of an aircraft according to claim 7, furthermore comprising means for activating the diversion flight plan.

16. The device for calculating a flight plan of an aircraft according to claim 8, furthermore comprising means for displaying alternatively, the whole of the diversion flight plan in the active flight plan, a line summarizing the location of the diversion flight plan at the junction point of the active flight plan.

17. The device for calculating a flight plan of an aircraft according to claim 8, furthermore comprising means for calculating and displaying on a dedicated page the various quantities of fuel for flying the diversion flight plan as well as the associated reserves.

18. The device for calculating a flight plan of an aircraft according to claim 9, furthermore comprising means for calculating and displaying on a dedicated page the various quantities of fuel for flying the diversion flight plan as well as the associated reserves.

19. The device for calculating a flight plan of an aircraft according to claim 8, furthermore comprising means for displaying on a navigation screen at the level of the junction point, the estimated quantity of fuel on arrival at the second destination.

20. The device for calculating a flight plan of an aircraft according to claim 9, furthermore comprising means for displaying on a navigation screen at the level of the junction point, the estimated quantity of fuel on arrival at the second destination.
